(19) United States
(12) Patent Application Publication
(10) Pub. No.: US 2025/0371276 A1
(43) Pub. Date: Dec. 4, 2025

(54) METHOD AND SYSTEM FOR GENERATING ONE-SHOT QUERIES

(71) Applicant: GOOGLE LLC, Mountain View, CA (US)

(72) Inventor: Keun Soo Yim, San Jose, CA (US)

(21) Appl. No.: 19/226,667

(22) Filed: Jun. 3, 2025

Related U.S. Application Data
(60) Provisional application No. 63/655,852, filed on Jun. 4, 2024.

(51) Int. Cl. G06F 40/30; G06F 40/169; G06F 40/226

(52) U.S. Cl. CPC G06F 40/30; G06F 40/169; G06F 40/226

(57) ABSTRACT

Implementations relate to processing multi-turn dialogs each showing (1) dialog turns that correspond to user input(s) providing user intent(s) and associated parameter(s), and (2) dialog turns that correspond to input(s) from a virtual assistant (or a human agent/responder) that are responsive to the user input(s). A multi-turn dialog (e.g., a pre-processed variation thereof) can be processed, using a generative model, to generate one or more one-shot queries summarizing the user input(s) of the multi-turn dialog. Whether the generated one-shot queries accurately reflect the user intent(s) and/or the associated parameters can be verified, and only verified one-shot queries are selected to form part of a dataset. The dataset can be used, for example, for training machine learning model(s) for handling a single, complex user query and/or for validating machine learning model(s).

### BACKGROUND

Current generative models, e.g., large language models (LLMs), have shown phenomenal generative semantic and compositional power and have been trained on extremely large and diverse language datasets. For example, LLM(s) have been trained to process natural language (NL) content and/or other input(s), to generate LLM output that reflects generative NL content and/or other generative content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”.

While capable of generating natural language content responsive to user input as described above, LLMs are less capable of handling user input (e.g., a single, complex user utterance describing several actions and related information/parameters) that requests to fulfill a task (e.g., change DNS settings on Acme router as described above, or send an email) which may (or may not) leverage external tools or services. To enhance the capability of LLMs in handling complex user input and/or in leveraging tools or services, a sufficiently large dataset having diverse training data needs to be generated, to train or fine-tune the LLMs in performing tasks, e.g., complex tasks such as food-ordering and calling a taxi. Each training instance that is stored as part of the diverse training data in the sufficiently large dataset will need to include a respective training instance input that describes actions (and/or parameters associated with the actions) accurately reflecting a respective user intent in performing a respective task.

### SUMMARY

Implementations disclosed herein relate to leveraging one or more generative models (e.g., large language models, “LLMs”) to automatically generate one-shot queries based on processing of multi-turn dialogs made available by various sources. The generated one-shot queries can be, for instance, action queries summarizing user requests/inputs to fulfill actions/tasks (e.g., one or more tasks) such as ordering food, requesting a taxi, or a combination thereof, etc. In some implementations, the generated one-shot queries can be verified, and a subset of the generated one-shot queries that are verified as accurately reflecting user intents can be stored as a dataset, to train, fine-tune, and/or evaluate one or more aspects of virtual assistants, chatbots, and other large language model (LLM)-based services (e.g., NLU and fulfillment systems thereof).

For example, in some implementations, a multi-turn dialog between a human user and a virtual assistant (or chatbot, or even a human agent/responder) can be processed as input, using an LLM, to generate a model output from which multiple one-shot query candidates (and corresponding confidence score) can be derived. The multi-turn dialog can be annotated to determine actions (and/or parameters associated with the actions) that accurately reflect a user intent, and the top ranked one-shot query candidate can be verified using the annotated acts (and/or parameters) and/or other factors. The top ranked one-shot query candidate, if verified, is saved in a one-shot query dataset. If not verified, the top ranked one-shot query candidate can be discarded.

By leveraging the LLMs in processing multi-turn dialogs made available by various sources, a large quantity of one-shot queries that truly and accurately reflect user intents and that come in diversified domains can be rapidly generated. Such large quantity of one-shot queries can be verified and those verified one-shot queries can be selected and be stored to form a dataset having huge amount of diverse data that accurately describes actions and parameters associated with the actions for training LLMs in efficiently handling complex user inputs (e.g., a single, one-paragraph user input) to perform corresponding tasks. This addresses the current issue where a standard benchmark for one-shot queries is not yet available, as existing benchmarks in the relevant natural language processing (NLP) have primarily focused on multi-turn dialogs that include human user requests and responses from human agents (or virtual assistants).

It is also noted that, the conventional approach to fulfill a user request that describes an action to be performed (e.g., “I want to order lunch from restaurant A”) often requires a NLU and fulfillment system to generate prompts (e.g., “what food would you like to order?”, “pick up or delivery?”, “when would you like to pick?”, etc.) that seek additional user inputs to provide information (e.g., “sushi”, “pick up at 12:30 pm”, etc.) for fulfilling the action which the user intends. However, the conventional approach would fail if given a user request that specifies all information (e.g., food to order, delivery method, etc.) needed to fulfill a user intent/action (e.g., food-ordering), as it relies on step-by-step interactions between a user and a virtual assistant to gather sufficient information to perform the action. This can be time-consuming, and low efficiency. The above-described dataset having huge amount of diverse data that accurately describes actions and parameters associated with the actions also enable LLM with phenomenal generative semantic and compositional power to be trained in handling single, complex user input that describes a sufficient number of actions and associated parameters, to complete corresponding tasks.

In various implementations, processors of a system for generating a task-based query dataset can acquire a plurality of multi-turn dialogs from one or more multi-turn dialog sources. In various implementations, for each of the plurality of multi-turn dialogs, the system can process a respective multi-turn dialog to generate a textual prompt, where the respective multi-turn dialog includes multiple user inputs and multiple system inputs that are responsive to the multiple user inputs, and where the respective multi-turn dialog is to fulfill a respective user intent via a respective application or a respective device.

In some of the various implementations, the textual prompt includes an instruction that instructs to summarize the multiple user inputs given the respective multi-turn dialog.

In various implementations, the system processes the textual prompt generated from the respective multi-turn dialog, using a generative model, to generate a respective model output from which content that includes a respective list of one-shot query candidates is derived. Optionally, each one-shot query candidate from the respective list summarizes the multiple user inputs and includes one or more actions and one or more parameters/values associated with the one or more actions to fulfill the respective user intent.

In some of the various implementations, the system processes the respective multi-turn dialog to generate the textual prompt by: pre-processing the respective multi-turn dialog to remove the multiple system inputs from the respective multi-turn dialog.

In some of the various implementations, the system processes the respective multi-turn dialog to generate the textual prompt by: determining whether the respective multi-turn dialog includes one or more user labels associated with the multiple user inputs; and in response to determining that the respective multi-turn dialog includes the one or more user labels associated with the multiple user inputs, pre-processing the respective multi-turn dialog to remove the one or more user labels from the respective multi-turn dialog.

In some of the various implementations, the system processes the respective multi-turn dialog to generate the textual prompt by: determining whether the respective multi-turn dialog includes any user label; and in response to determining that the respective multi-turn dialog does not include any user label, pre-processing the respective multi-turn dialog to add one or more user labels for the multiple user inputs.

In various implementations, the system determines whether the respective list of one-shot query candidates or a portion of the respective list is verified (e.g., whether one or more one-shot query candidates accurately reflect the user intent indicated by the multi-turn dialog). In some of the various implementations, the content derived from the respective model output includes a respective confidence score for each one-shot query candidate in the respective list of one-shot query candidates. In this case, the system can verify the respective list of one-shot query candidates or the portion of respective list by: selecting, based on the respective confidence scores, a top ranked one-shot query candidate having a highest confidence score from the respective list, and determining whether the top ranked one-shot query candidate is a verified query.

In some of the various implementations, the system can further process the respective multi-turn dialog to annotate one or more actions associated with the respective user intent, and/or one or more parameters (or values) associated with the respective user intent. In this case, the system can verify the respective list of one-shot query candidates or the portion of the respective list using, for instance, the one or more annotated actions (and/or the one or more annotated values) that are associated with the respective user intent. In some of the various implementations, the system can process the respective multi-turn dialog to annotate the one or more actions and/or the one or more values by: generating an additional textual prompt based on the respective multi-turn dialog; and processing the additional textual prompt, using the generative model or an additional generative model, to generate a model output from which annotated content that annotates the one or more actions and/or the one or more values is derived.

In various implementations, the system stores a first one-shot query candidate in a one-shot query dataset, in response to the first one-shot query candidate from the respective list being verified as accurately reflecting the user intent.

In various implementations, in response to a second one-shot query candidate from the respective list not being verified, the system discards the second one-shot query candidate, without storing the second one-shot query candidate in the one-shot query dataset. In various implementations, the system trains, fine-tunes, or validate one or more machine learning (ML) models using the one-shot query dataset.

The one-shot query dataset can include verified one-shot queries associated with different user intents (e.g., food-ordering, calling a taxi, a combination thereof, etc.) As a non-limiting example, the one-shot query dataset can include a verified one-shot query (e.g., with a user intent of “booking a taxi”) such as, “I am requesting a taxi from FF Bed and Breakfast to DD Pizzeria. I would like to arrive at 1 μm to meet my friend for lunch. I would like the contact information for the driver so that I can reach them if necessary.” As another example, the one-shot query dataset can include a verified one-shot query (e.g., with a user intent of “ordering food”), such as, “I would like to place an order for Indian food for three people. I would like to order beef shish kebabs for one person, chicken tandoori for one person, and green curry with chicken for the third person. I would also like to add garlic to all of the dishes.”

As a further example, the one-shot query dataset can include a verified one-shot query (e.g., with user intents of “ordering food”, “search attraction” and “booking taxi service”), such as, “I am planning a trip to Cambridge and I need your help with booking a restaurant and a taxi. I am looking for an expensive restaurant serving British food in the west area of Cambridge. I would like to book a table for one on Tuesday at 7:30 PM. I am also looking for an attraction in the same area. Can you recommend one and provide me with their phone number? I would like to take a taxi between the restaurant and the attraction. I would like to leave the attraction by 7:15 PM.”

It is noted that, training, fine-tuning, or validating one or more machine learning (ML) models using the examples of verified one-shot queries as shown above enhances capabilities of virtual assistant, chatbot, or other interactive services or applications that include (or access) one or more of the ML models in handling complex user input (e.g., a single typed or spoken user input as complex as the examples given above) by having an accurate understanding of user intent(s) in the complex user input.

The preceding is presented as an overview of only some implementations disclosed herein. These and other implementations are disclosed in additional detail later in this disclosure. For instance, the system can further determine a type (or category) of a user intent for each multi-turn dialog from the plurality of multi-turn dialogs. In some implementations, different multi-turn dialogs corresponding to different types/categories of user intents can be pre-processed in a different manner. For instance, for a multi-turn dialog corresponding to a user intent of “ordering food”, the multi-turn dialog can be pre-processed to remove any user labels. For instance, for a multi-turn dialog corresponding to a user intent of “ordering food and reserving a taxi”, the multi-turn dialog can be pre-processed to add user labels (or reserve existing user labels). The present disclosure, however, is not limited to descriptions herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2A illustrates an example scenario where one or more one-shot queries are generated using techniques described in accordance with various implementations of the present disclosure.

FIG. 2B illustrates a user interface showing an example of a one-shot query generation request including a multi-turn dialog (e.g., pre-processed) and/or an instruction to generate a one-shot query based on the multi-turn dialog, in accordance with various implementations of the present disclosure.

FIG. 2C illustrates a user interface showing another example of a one-shot query generation request including a multi-turn dialog (e.g., pre-processed) and/or an instruction to generate a one-shot query based on the multi-turn dialog, in accordance with various implementations of the present disclosure.

FIG. 2D illustrates a user interface showing a further example of a one-shot query generation request including a multi-turn dialog (e.g., pre-processed) and/or an instruction to generate a one-shot query based on the multi-turn dialog, in accordance with various implementations of the present disclosure.

FIG. 2E illustrates a user interface showing a one-shot query generated based on the multi-turn dialog in FIG. 2B, in accordance with various implementations of the present disclosure.

FIG. 2F illustrates an example of metadata associated with an annotated multi-turn dialog, in accordance with various implementations of the present disclosure.

FIG. 2G illustrates a user interface showing an additional example of a one-shot query generation request including a multi-turn dialog (e.g., pre-processed) and/or an instruction to generate a one-shot query based on the multi-turn dialog, in accordance with various implementations of the present disclosure.

FIG. 2H illustrates a user interface showing an even further example of a one-shot query generation request including a multi-turn dialog (e.g., pre-processed) and/or an instruction to generate a one-shot query based on the multi-turn dialog, in accordance with various implementations of the present disclosure.

FIG. 3 illustrates an example of a method for generating one or more one-shot queries, in accordance with various implementations of the present disclosure.

FIG. 4 depicts an example of a method for generating a one-shot query dataset, in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

Techniques described herein are directed to generating one-shot queries that are task-oriented (or action-oriented) and that can be used in training, fine-tuning, and/or validating (e.g., assessing the quality) virtual assistants, chatbots, and other large language model (LLM)-based services. A one-shot query can be, for instance, an action query summarizing user requests/inputs (e.g., from a multi-turn dialog) to fulfill one or more tasks such as ordering food, requesting a taxi, or a combination thereof, etc. In various implementations, the action query can be utilized as a training instance input (corresponding to a single, complex user input) for generating a training instance to train, fine-tune, and/or validate (e.g., assess the quality) virtual assistants, chatbots, and other large language model (LLM)-based services. Training or fine-tuning the virtual assistants, chatbots, and other large language model (LLM)-based services using such training instance enables the virtual assistants, chatbots, and other large language model (LLM)-based services to handle a complex user input (e.g., a single typed input describing various actions and/or their associated parameters) for fulfilling tasks that utilize third-party applications or services (e.g., an application programming interface “API” for a food-ordering application).

The conventional approach to fulfill a user request of a user that describes an action to be performed often requires multiple dialog turns to resolve the full extent of a user intent indicated by the user request. This results in a prolonged duration of dialog (e.g., a multi-turn dialog) and a corresponding prolonged utilization of client device, server, and/or network resources utilized in the dialog. For example, resolving a user request of “I want to order lunch from restaurant A” can require a conventional system to generate and provide multiple prompts (e.g., “what food would you like to order?”, “pick up or delivery?”, “when would you like to pick?”, etc.) that seek additional user inputs to provide information (e.g., “sushi”, “pick up at 12:30 pm”, etc.) for fully resolving the user intent (e.g., ordering food)—and processing of those additional user inputs.

However, the conventional approach would fail for various actions if given a one-shot query (e.g., a single dialog turn from the user), that specifies all information (e.g., food to order, delivery method, etc.) needed to fulfill a user intent/action (e.g., food-ordering), as it relies on multi-turn interactions between a user and a virtual assistant (e.g., NLU engine thereof) to gather sufficient information to perform the action.

Advances in generative models (e.g., LLM(s)) can enable processing of a one-shot query that fully describes a complex action, to generate corresponding data for fulfilling the complex action. However, generative models can suffer from hallucinations and/or other problems, which can, for various actions, present risks to data security, can lead to inadvertent control of smart device(s) and/or other component(s), and/or can lead to completion of unintended transaction(s) (requiring significant computational resources to undo).

For example, if processing of a single query of “email the spreadsheet of next month's sales forecast to Joe in accounting” generates fulfillment data that includes hallucination(s), it can result in emailing of the “spreadsheet of next month's sales data” to the incorrect recipient and/or in emailing of an incorrect document to “Joe in accounting”.

Accordingly, there is a need for a large set (e.g., thousands, tens of thousands) of one-shot queries, optionally paired with corresponding ground truth data, that can be used for training, fine-tuning, and/or validating generative model based assistants to enable mitigation of hallucinations or other errors for one-shot queries. For example, such a large set can be utilized to assess the accuracy and/or robustness of such an assistant prior to deployment. However, manually curating such a large set can require significant client device resources and/or can result in error(s) in some of the one-shot queries (which negatively impacts their efficacy for use in training, fine-tuning, and/or validating). As a result, there is a need for an approach that automatically generates a large dataset of one-shot queries.

The technique disclosed herein leverages a generative model (e.g., LLM) to automatically generate one-shot queries based on processing of already existing multi-turn dialogs (or a pre-processed variation thereof). Various implementations seek to ensure that the generated one-shot queries accurately reflect the full intent of user inputs in the multi-turn dialogs through utilization of action-type dependent LLM(s) processing in generating (and/or verifying) one-shot query candidate(s) before selecting a one-shot query candidate as a one-shot query to be included in a one-shot query dataset.

For instance, a multi-turn dialog can be processed as input, using an LLM, to generate a model output from which multiple one-shot query candidates (and corresponding confidence scores) can be derived. Optionally, the LLM processing can be dependent on a type of action reflected by the multi-turn dialog. For example, for a first type of action, user utterances/inputs and system utterances/input, and/or corresponding user labels and/or system labels, from a multi-turn dialog, can be processed using the LLM, in generating one-shot query candidates. However, for a second type of action, the user utterances, without the system utterances, from a multi-turn dialog, can be processed using the LLM in generating one-shot query candidates. Which processing technique is utilized for a type of action can be based on analysis of performance of multiple processing techniques for a subset of multi-turn dialogs of the type. The one-shot query candidates can be evaluated to select at least one as a verified one-shot query for saving in the one-shot query dataset.

For example, the multi-turn dialog can have annotations that reflect acts/actions (and/or parameters associated with the acts) that accurately reflect a user intent for the multi-turn dialog, and whether the top ranked one-shot query candidate is verified can be determined using the annotated acts (and/or parameters) and/or other factors. The top ranked one-shot query candidate, if verified, is saved in the one-shot query dataset. If not verified, the top ranked one-shot query candidate can be discarded.

Implementations described herein therefore leverage existing multi-turn dialogs to automatically generate one-shot queries. This obviates the need to utilize client device resources in manually curating such one-shot queries. Moreover, implementations generate and/or evaluate one-shot queries in a manner that ensures selected one-shot queries accurately reflect corresponding user intent(s) of corresponding multi-turn dialogs and are free from hallucinations. This ensures that the one-shot queries can be utilized in mitigating occurrences of hallucinations by automated assistants in responding to one-shot queries (e.g., through utilization of the verified one-shot queries in training, fine-tuning, and/or validating).

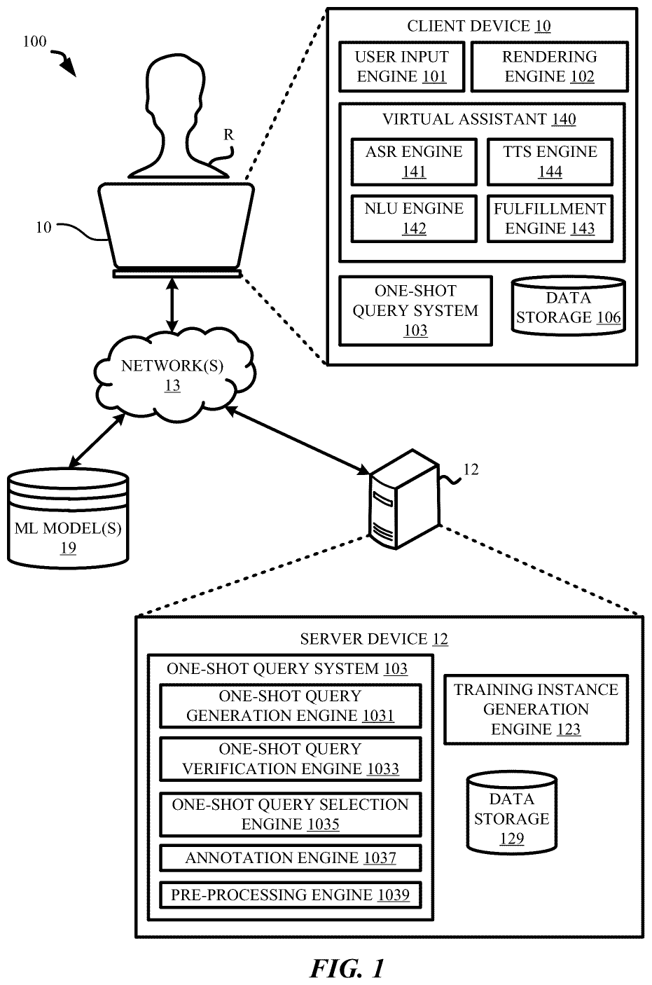

FIG. 1 is a block diagram of an example environment 100 that demonstrates various aspects of the present disclosure, and in which implementations disclosed herein may be implemented. As shown in FIG. 1, the environment 100 can include a client computing device 10 (“client device”) that is in communication with a server computing device 12 (“server device”). The client computing device 10 can be in communication with the server computing device 12, via one or more networks 13. The one or more networks 13 can include, for example, a local area network (LAN), a wide area network (WAN) such as the Internet, and/or any other appropriate network. In some implementations, the client computing device 10 (and/or the server computing device 12) can be in communication with one or more machine learning (ML) models, via the one or more networks 13.

In some implementations, the client computing device 10 can be, for example, a desktop computing device, a laptop computing device, a tablet computing device, or a mobile phone computing device. In some implementations, the client computing device 10 can also be a computing device of a vehicle (e.g., an in-vehicle entertainment system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

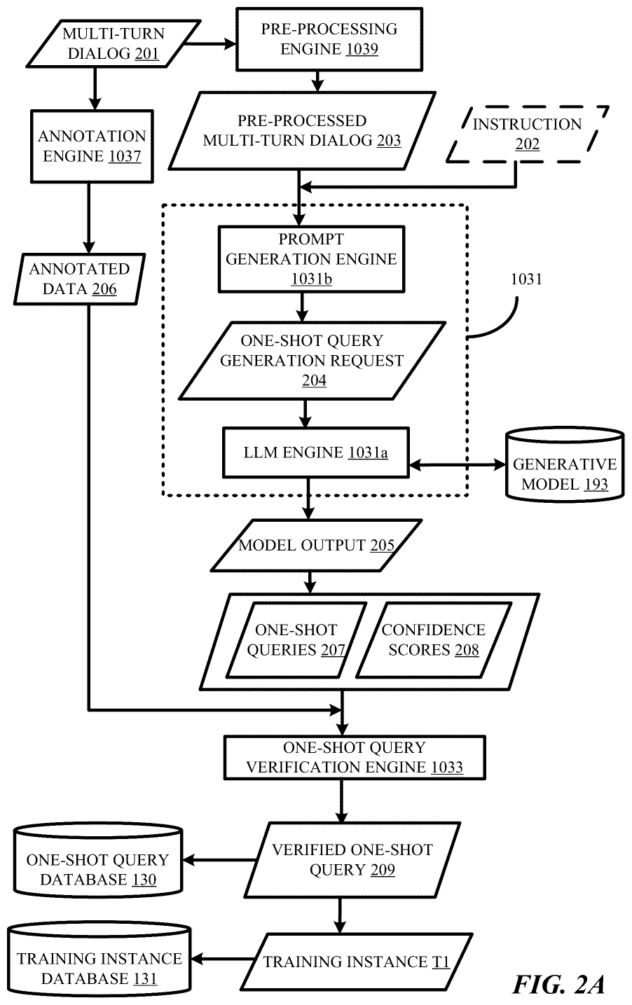

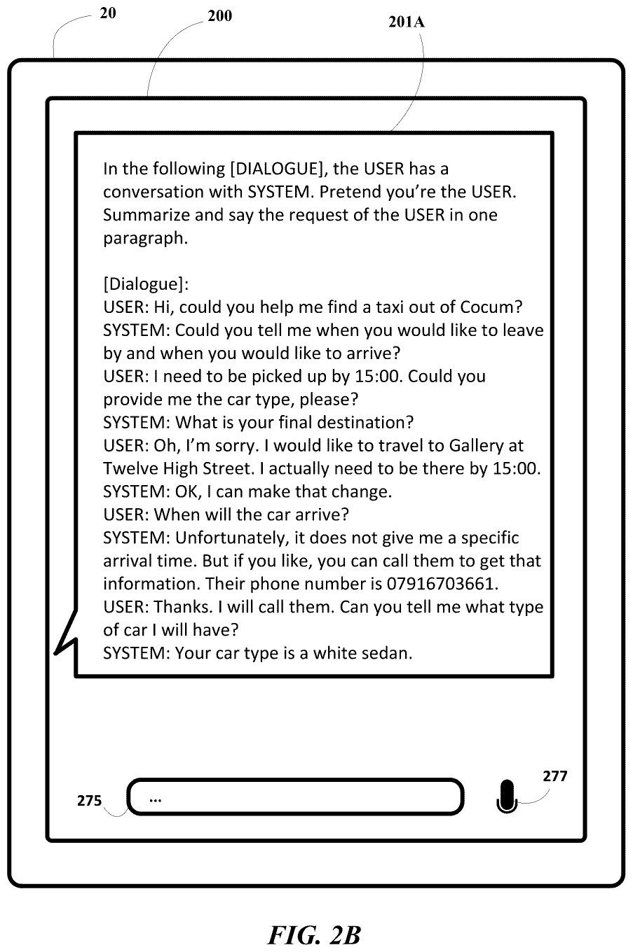

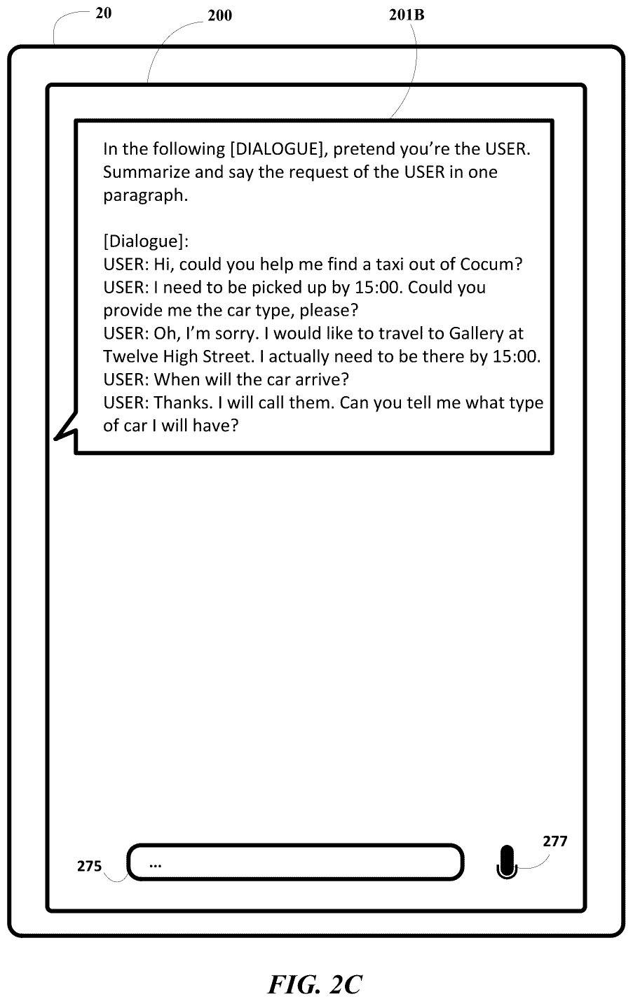

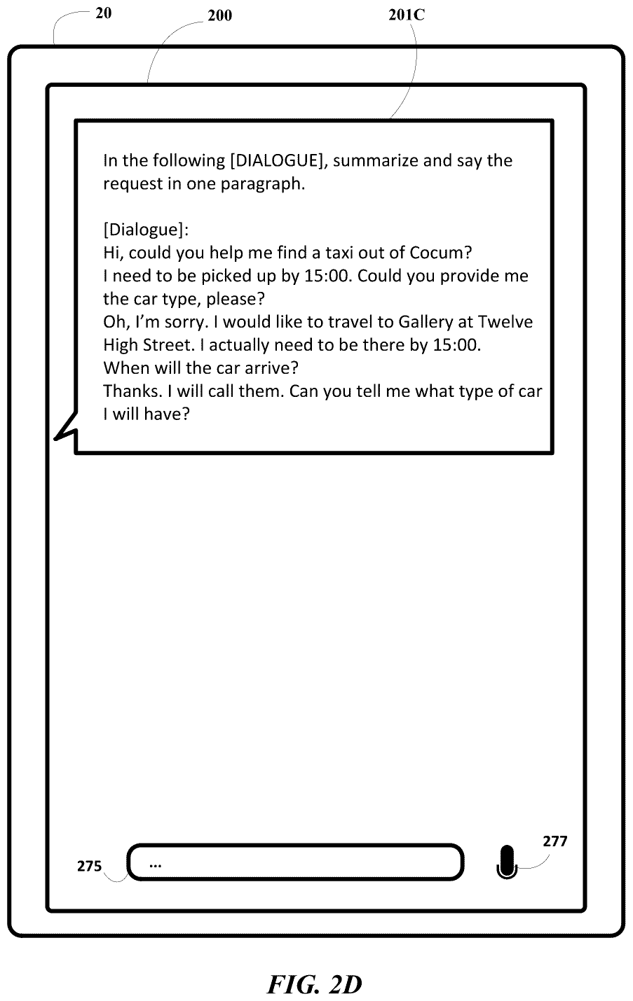

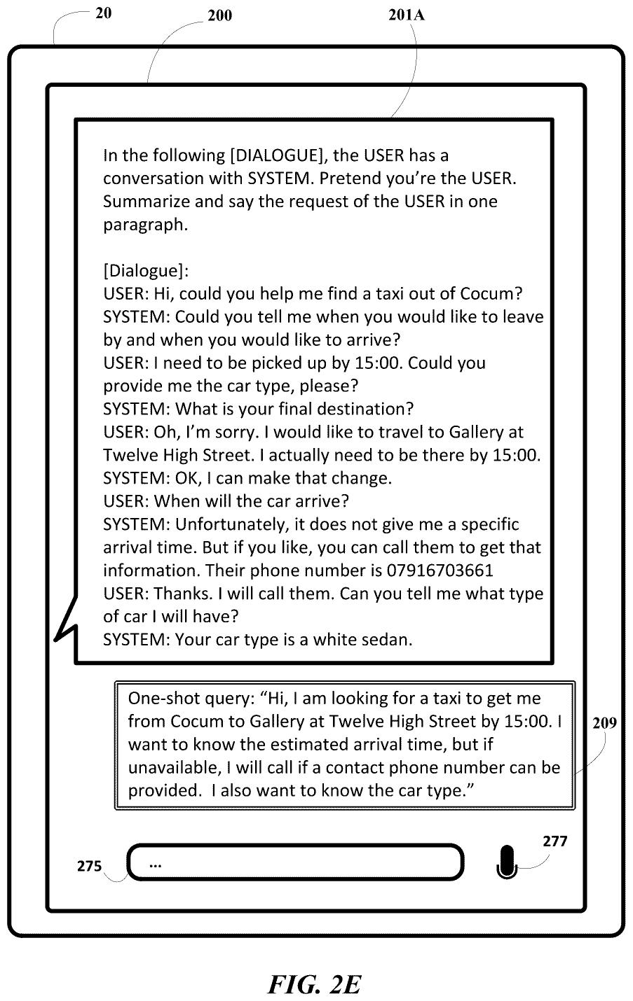

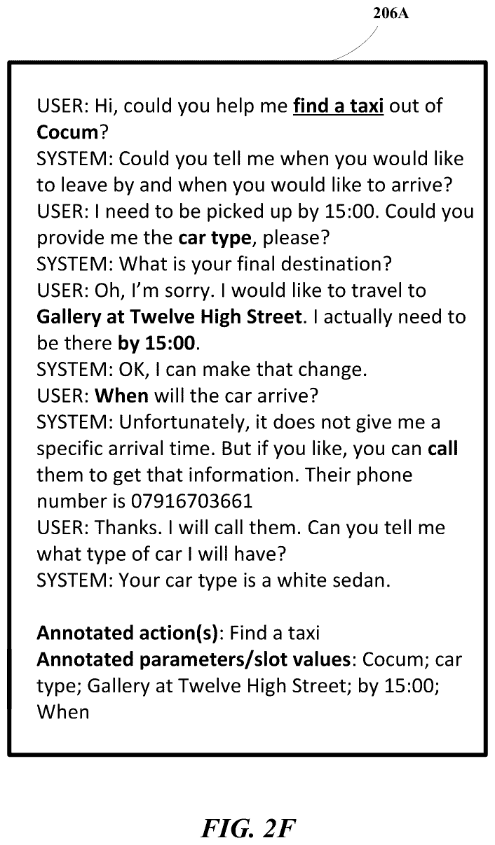

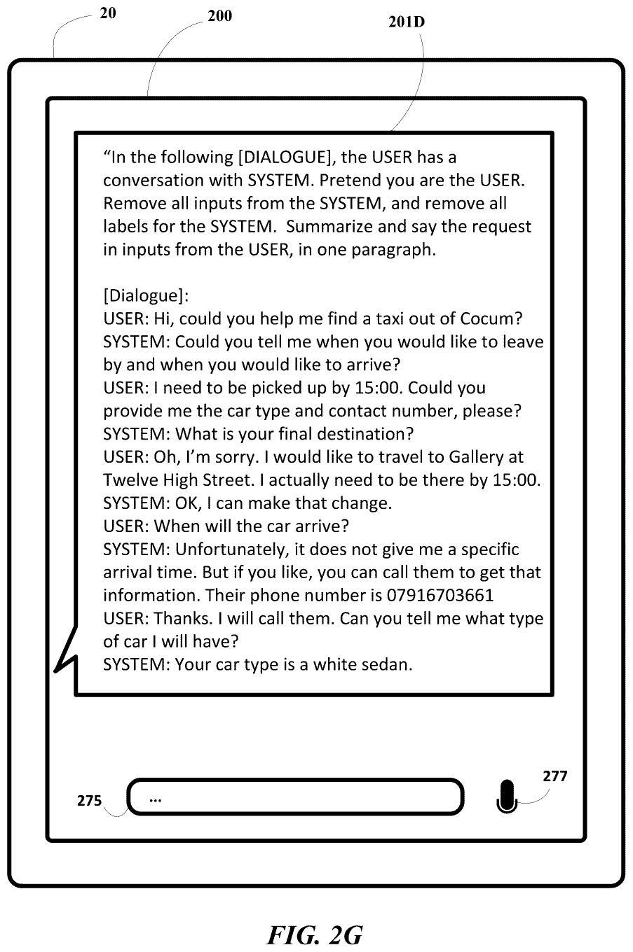

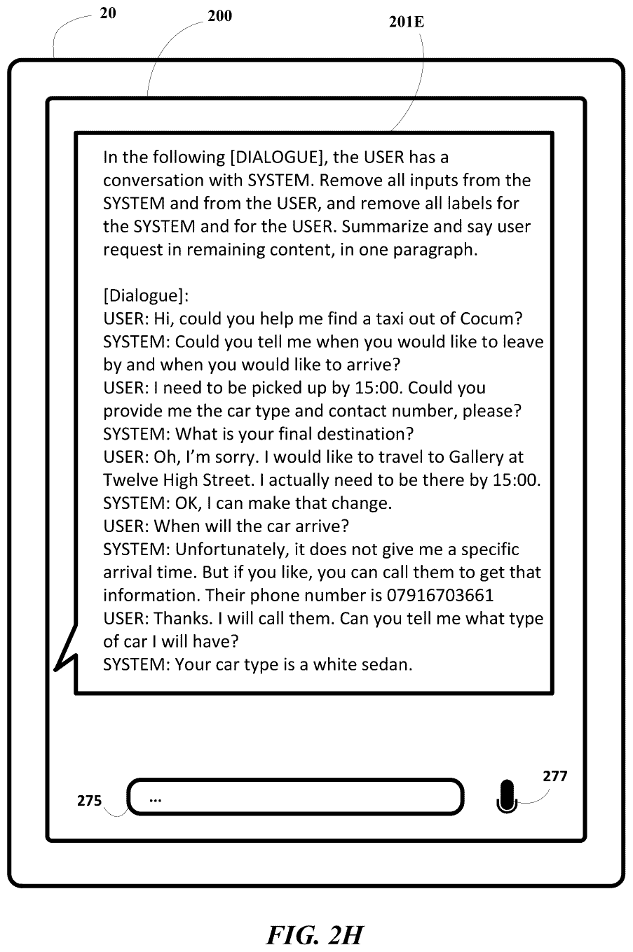

In various implementations, the client computing device 10 can include a user input engine 101 that is configured to detect user input provided by a user (e.g., user R) of the client computing device 10. The user input may be provided by the user using one or more user interface input devices, such as a keyboard, a touch screen, a microphone, etc. The user input can be typed input, touch input, audible input, or any other applicable type of input. For example, the client computing device 10 can be equipped with a keyboard to receive typed input, and/or a mouse (or one or more hardware buttons) to receive a user click that selects one or more graphical user interface (GUI) elements that is rendered visually at a user interface of the client computing device 10. The typed input can be received, for instance, via an input field (e.g., 275 at a user interface 200 of client device 20, as shown in FIG. 2B) of a graphical user interface (GUI) of an application. Additionally, or alternatively, the client computing device 10 can be equipped with one or more microphones that capture audio data, such as audio data capturing spoken utterances of the user and/or other sounds in an environment of the client computing device 10. Optionally, the audio data capturing the spoken utterances can be received in response to a user selecting an icon (e.g., 277 in FIG. 2B) indicating recording of audio data. Additionally, or alternatively, the client computing device 10 can be equipped with one or more vision components that are configured to capture vision data corresponding to images and/or movements (e.g., gestures) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input that is directed to the client computing device 10.

In various implementations, the client computing device 10 can include a rendering engine 102. The rendering engine 102 can be configured to provide content for audible and/or visual presentation to a user of the client computing device 10 using one or more user interface output devices. For example, the client computing device 10 can be equipped with one or more speakers that enable content (e.g., “The processing of the dialogs has been completed, do you want to start verifying the 10,000 one-shot queries generated based on the processing?”) to be provided for audible presentation to the user via the client computing device 10. Additionally, or alternatively, the client computing device 10 can be equipped with a display or projector that enables content (e.g., of one or more one-shot queries generated using techniques disclosed herein) to be provided for visual presentation to the user via the client computing device 10.

In various implementations, the client computing device 10 can include, or otherwise access, a one-shot query system 103. In some implementations, the one-shot query system 103 can include a one-shot query generation engine 1031, a one-shot query verification engine 1033, and a one-shot query selection engine 1035. The one-shot query generation engine 1031 can, for instance, process a plurality of multi-turn dialogs each including multiple user inputs (from a respective user) and multiple agent inputs (e.g., from a human agent, from a virtual assistant, etc.) for performing a respective task. The one-shot query generation engine 1031 can process each of the plurality of multi-turn dialogs, to generate a respective one-shot query candidate (or a respective set of one-shot query candidates).

The one-shot query verification engine 1033 can process each of the respective one-shot query candidates (or each one-shot query candidate from the respective sets of one-shot query candidates) generated based on processing the plurality of multi-turn dialogs, to verify whether each of the respective one-shot query candidates (or each one-shot query candidate from the respective sets of one-shot query candidates) accurately reflects a respective user intent. The one-shot query selection engine 1035 can select a subset of one-shot query candidates, from the respective one-shot query candidates (or the respective sets of one-shot query candidates), that are verified (e.g., as accurately reflecting a respective user intent) to build a one-shot query dataset.

In some implementations, the one-shot query system 103 can include an annotation engine 1037 that annotates actions and parameters (see bolded terms in FIG. 2F as an example) associated with the actions in each of the plurality of multi-turn dialogs as described above. In some implementations, the client computing device 10 can include a data storage 106, and the annotated actions and parameters associated with the annotated actions can be stored in the data storage 106 (or a data storage 129 at the server computing device 12). In some implementations, given a one-shot query candidate determined based on processing a corresponding multi-turn dialog, the one-shot query verification engine 1033 can verify whether the respective one-shot query candidate accurately reflects a respective user intent based on comparing the respective one-shot query candidate with annotated actions (and/or associated parameters) annotated from the corresponding multi-turn dialog.

In some implementations, the one-shot query dataset can be stored in a one-shot query database 130, e.g., of the data storage 106 and/or at the data storage 129. It is noted that, while the client computing device 10 is illustrated in FIG. 1 to include the one-shot query system 103, the one-shot query system 103 (or a portion thereof, e.g., one-shot query generation engine 1031) can be stored at the server computing device 12, or distributed over one or more devices (e.g., 10 and 12, and/or more).

In some implementations, the one-shot query generation engine 1031 can include an LLM engine 1031a (see FIG. 2A) that accesses one or more machine learning (ML) models 19 (e.g., a generative model 193, as shown in FIG. 1B), and/or a prompt generation engine 1031b. In some implementations, the LLM engine 1031a can access the one or more ML models 19, for instance, via the one or more networks 13. In some implementations, the LLM engine 1031a (of the one-shot query generation engine 1031) can process a multi-turn dialog, using a generative model (e.g., 193 in FIG. 1B), to generate one or more one-shot query candidates. For example, the prompt generation engine 1031b can generate a one-shot query generation request based on the multi-turn dialog, and such one-shot query generation request can be processed, by the LLM engine 1031a and using the generative model 193, to generate a model output reflecting the one or more one-shot query candidates. In this example, the one-shot query generation request can include content of the multi-turn dialog, and an instruction to generate a one-shot query based on the content of the multi-turn dialog. In some implementations, the instruction to generate the one-shot query can be, for instance, an instruction to generate a summary that summarizes user intent(s) from the multi-turn dialog. The instruction to generate the one-shot query can, optionally, request the summary that summarizes user intent(s) from the multi-turn dialog (i.e., the one-shot query) to be one-paragraph long.

In some implementations, the multi-turn dialog (e.g., processed to generate the one or more one-shot query candidates) can be, for instance, a human-to-computer dialog having multiple dialog turns showing interactions between a user (e.g., a human user) and a virtual assistant. The virtual assistant can be an interactive software application also referred to as “digital agent,” “chatbot,” “interactive personal assistant,” “intelligent personal assistant,” “conversational agent,” etc. The multiple dialog turns can include a plurality of dialog turns each corresponding to a user input from a user (e.g., a human user) that provides an action (and/or a parameter) for performing a task. The multiple dialog turns can further include one or more multiple dialog turns each corresponding to input from the virtual assistant, e.g., in confirming information (or seeking additional user input from the user) to fulfill the task.

In some implementations, the multi-turn dialog (e.g., processed to generate the one or more one-shot query candidates) can be a dialog having multiple dialog turns showing interactions between a user (e.g., a human user) and a human agent. In this case, the multiple dialog turns can include a plurality of dialog turns each corresponding to a user input from a user (e.g., a human user) that provides an action (and/or a parameter) for performing a task. The multiple dialog turns can further include one or more multiple dialog turns each corresponding to input from a human agent (e.g., a waitress, etc.), in confirming information or seeking additional user input to fulfill the task. In some implementations, the multi-turn dialog can be retrieved or selected, along with other multi-turn dialog(s), from a multi-turn dialog database.

In some implementations, the one-shot query system 103 can include a pre-processing engine 1039 that pre-processes a multi-turn dialog. In some implementations, given a multi-turn dialog, the pre-processing engine 1039 can pre-process the multi-turn dialog by formatting the multi-turn dialog in a format having a user label (e.g., “USER”) for dialog turns corresponding to user input (e.g., spoken utterance, typed input, etc.), and/or having a system label (e.g., “SYSTEM”) for dialog turns corresponding to input from a virtual assistant (or a human agent). In this case, the aforementioned instruction to generate the one-shot query can be, for instance, “In the following dialogue, the USER has a conversation with SYSTEM. Pretend you're the USER. Summarize and say the request of the USER in one paragraph.”

In some implementations, the pre-processing engine 1039 can pre-process the multi-turn dialog to remove dialog turns corresponding to input from a virtual assistant (or from a human agent). In some implementations, additionally, the pre-processing engine 1039 can pre-process the multi-turn dialog to remove any user label (if there is any) from dialog turns corresponding to user input, in addition to remove dialog turns corresponding to input from a virtual assistant (or from a human agent).

In implementations where the multi-turn dialog is pre-processed, the aforementioned one-shot query generation request (processable using the generative model 193 to generate one or more one-shot query candidates) can be generated based on the content of the pre-processed multi-turn dialog. In some implementations, the generative model 193 can be trained or fine-tuned so that the aforementioned one-shot query generation request is not needed, and the multi-turn dialog (or the pre-processed multi-turn dialog) can be processed as input, using the generative model 193, to generate the one or more one-shot query candidates.

In some implementations, training (or fine tuning) of the generative model (e.g., 193) can be performed through supervised learning and/or reinforcement learning. The reinforcement learning can be, for instance, reinforcement learning from human feedback (“RLHF”) that incorporates human feedback into the training or fine-tuning of the LLM to align output of the LLM with human preferences.

In various implementations, the client computing device 10 can include, or otherwise access, one or more applications. The one or more applications can include, for instance, the aforementioned virtual assistant (e.g., 140 in FIG. 1) that enables human-to-computer dialogues between a user of the virtual assistant and the virtual assistant. In some implementations, the virtual assistant 140 can include a plurality of local components. The plurality of local components can include, for instance, an automatic speech recognition (ASR) engine 141, a natural language understanding (NLU) engine 142, a fulfillment engine 143, and/or a text-to-speech (TTS) engine 144. In some implementations, the ASR engine 141, the NLU engine 142, the fulfillment engine 143, and/or the TTS engine 144 may be, but does not necessarily need to be, included in the virtual assistant 140. In some implementations, additionally or alternatively, the plurality of local components at the client computing device 10 can include other component(s) such as the LLM engine 1031a.

In some implementations, the ASR engine 141 (and/or a cloud-based ASR engine) can process, using one or more streaming ASR models (e.g., a recurrent neural network (RNN) model, a transformer model, and/or any other type of ML model capable of performing ASR), streams of audio data that capture spoken utterances, to generate corresponding streams of ASR output. The ML model(s) can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 141 and/or 1411 can select one or more of the ASR hypotheses as corresponding recognized text (“transcript”) that corresponds to the spoken utterance(s) (e.g., selected based on the corresponding predicted measures).

In some implementations, the NLU engine 142 can determine semantic meaning(s) of audio and/or text converted by the ASR engine from audio, and decompose the determined semantic meaning(s) to determine intent(s) and/or parameter(s) for an assistant action. For example, the NLU engine 142 can determine an intent and/or parameters for an assistant action based on the aforementioned recognition of the spoken utterance generated by the ASR engine 191.

In some implementations, the NLU engine 142 can resolve the intent(s) and/or parameter(s) based on a single utterance of a user. In this case, the fulfillment engine 143 can receive the intent and/or parameter(s) of the intent to fulfill the intent by performing a corresponding assistant action via the virtual assistant 140. For example, given a single utterance of “what's the weather today in Louisville?”, the fulfillment engine 143 can fulfill the intent (e.g., a search intent) by: (1) causing a search engine to search the Internet using a search parameter of “weather today in Louisville” for an answer/response to the user query of “what's the weather today in Louisville?”, (2) generating fulfillment information (e.g., “it's cloudy outside, with a temperature of 26° C.”), based on a search result (e.g., “Louisville, KY, Monday 11:00 am, cloudy, 26° C.”) of the search, and/or (3) rendering the fulfillment information to the user of the client computing device 10 as the answer (or response).

As another example, given a single utterance of “set the thermostat to 72 F”, the fulfillment engine 143 can receive an intent (e.g., control <device>) and/or parameter(s) (e.g., device name of “thermostat”, temperature of “72 F”) for an assistant action that causes a thermostat to set room temperature at 72 F. In this example, the fulfillment engine 143 can fulfill the intent by generating and forwarding a control signal to the thermostat, where the control signal causes the thermostat to set the room temperature at 72 F.

In some implementations, given a single utterance to perform a complex task, such as “I want to book a taxi”, the NLU engine 142 can determine that the single utterance is insufficient to fulfill an assistant action (e.g., the intent not resolved, and/or not all parameters associated with the intent resolved). In this case, the NLU engine 142 can generate one or more prompts (e.g., a first prompt of “where do you want to go”, and a second prompt of “where do you need the taxi to pick you up?”) based on unresolved intent(s) and/or parameters (e.g., unresolved pickup location and unresolved destination), where those prompts can be rendered to the user, and user response(s) (e.g., a first user response of “I want to go to La Margherita”, and a second user response of “pick me up at Hakka”) to those prompt(s) can be utilized by the NLU engine 142 in resolving intent(s) and/or parameter(s). In those situations, the NLU engine 142 can optionally work in concert with a dialog manager engine (not illustrated) that determines unresolved intent(s) and/or parameter(s) and/or generates corresponding prompt(s).

In some implementations, the NLU engine 142 cannot resolve the intent(s) and/or cannot determine all parameter(s) for the intent(s), to fulfill an assistant action. For instance, the NLU engine 142 may receive a single user utterance including complex user request(s), such as “I would like to order two poke aloha bowls and four poke tacos for take-out”, or “I am looking for a restaurant called Thanh Binh that can accommodate 6 people on Friday at 12:00. I would also like to book a taxi for 6 people from the concert hall to the restaurant at 11:00”. In this case, the existing NLU engine 142 may fail to respond to such single user utterance as it is currently not configured to handle a single user utterance having complex information, while capable of handling simpler requests such as “turn on the kitchen light”. As a result, the fulfillment engine 143 can generate a default response, such as “Sorry, I don't understand. Please try again.” Such default response can be rendered by the rendering engine 102 to the user.

In some implementations, due to the recent development in generative models, the NLU engine 142 can utilize one or more NLU machine learning models in determining intent(s) and/or parameter(s). However, there is a need to train or fine-tune the one or more NLU machine learning models in handling a single user utterance (or other type of input) that requests performance of a task (e.g., food-ordering) having various task parameters (e.g., restaurant to order food from, specific food to order, delivery method, pickup location, pickup time, etc.). The techniques disclosed in this disclosure address one or more issues in training or fine-tuning the one or more NLU machine learning models. For example, the one-shot query dataset can provide diverse training data to train or fine-tune the one or more NLU machine learning models.

In some implementations, the TTS engine (e.g., 144) can process, using TTS model(s), corresponding streams of textual content (e.g., content generated based on LLM or a predetermined text, etc.) to generate synthesized speech audio data that includes computer-generated synthesized speech. In additional or alternative implementations, the synthesized speech audio data can be pre-cached in memory or in one or more databases accessible by the client computing device 10.

In some implementations, the one or more applications can additionally, or alternatively, include a social media application, a video player, a search application, a note-taking application, a shopping application, a messaging application, and/or any other appropriate applications (or services) installed at, or accessible via, the client computing device 10.

In various implementations, the generative model 193 can be a large language model (LLM) having less than 100 billion parameters, more than 100 billion parameters, or over 200 billion parameters, etc. The greater the number of parameters of an LLM, the more complex (or sophisticated) a task (e.g., specified in a user query or request) the LLM can handle. The LLM may be stored at client computing device 10, or at the server computing device 12. For instance, if the memory of the client computing device 10 restricts the storing of the LLM at the client computing device 10 or if a length of a textual prompt to be processed using the LLM exceeds a predetermined token length, the LLM may be stored at the server device 12. For instance, if the memory of the client computing device 10 does not restrict the storing of the LLM at the client computing device 10, the LLM may be stored at the client computing device 10, to reduce a latency in completing a task (e.g., specified in the user query or request), for instance, by avoiding data communications via the one or more networks 13.

In some implementations, when the generative model 193 is stored at the client computing device 10, the maximum token length of content (e.g., text) processable using the LLM may be a first maximum token length (e.g., 10,000). In some implementations, when the generative model 193 is stored at the server device 12, the maximum token length of content (e.g., text) processable using the generative model may be a second maximum token length (e.g., 30,000) that is greater than the first maximum token length. The maximum token length can be a maximum number of tokens (which can be parsed from a user input) that is allowed for processing, in a single iteration, using the generative model.

In some implementations, the generative model 193 can be a transformer-based LLM. One non-limiting example of such LLM is GOOGLE'S Pathways Language Model (PaLM). Another non-limiting example of such LLM is GOOGLE'S Language Model for Dialogue Applications (LaMDA).

In various implementations, the server computing device 12 can be, for example, a web server, one or more blade servers acting together to provide “cloud” infrastructure, or any other type of server as needed. In various implementations, the server computing device 12 can include cloud-based components the same as or similar to the plurality of local components installed at the client computing device 1. For example, the server computing device 12 can include a cloud-based ASR engine, a cloud-based NLU engine, a cloud-based fulfillment engine, cloud-based TTS engine, a cloud-based prompt-generating engine (not illustrated), and/or a cloud-based LLM engine. In some implementations, the cloud-based prompt-generating engine (e.g., the generative model 193) can be configured to generate a text prompt based on a pre-processed multi-turn dialog, where the text prompt is processable using one or more ML models described in this disclosure. It is noted that, however, the one or more ML models can be so trained or fine-tuned that, instead of the text prompt, the pre-processed multi-turn dialog can be processed as input using the one or more ML models. In this case, the prompt-generating engine (or the cloud-based prompt-generating engine) may not be needed.

In some implementations, the server computing device 12 can further include a training instance generation engine 123. The training instance generation engine 123 can be applied to generate one or more training instances to train or fine-tune one or more machine learning models (e.g., a NLU machine learning model). For example, the one or more machine learning models can be trained or fine-tuned, e.g., using a first training instance (e.g., T1 in FIG. 2A) of the one or more training instance, via supervised learning or via reinforcement learning from human feedback (RLHF).

For instance, the first training instance can include a one-shot query selected (e.g., based on such one-shot query being a verified query) from the aforementioned one or more one-shot query candidates, as a first training instance input. The first training instance can further include a ground truth output, e.g., generated based at least on the multi-turn dialog (or a pre-processed variation thereof). For instance, the training instance generation engine 123 can generate the ground truth output based on the multi-turn dialog and metadata (e.g., API document) associated with external tools or other services (e.g., APIs for a food-ordering application, for a ride-sharing application, etc.) for performing a task that fulfills user intent(s) in the selected one-shot query.

FIG. 2A illustrates an example scenario where one or more one-shot queries are generated using techniques described in accordance with various implementations of the present disclosure. FIGS. 2B, 2C, 2D each illustrates a user interface showing an example of a one-shot query generation request including a multi-turn dialog (e.g., pre-processed) and/or an instruction to generate a one-shot query based on the multi-turn dialog, in accordance with various implementations of the present disclosure. FIG. 2E illustrates a user interface showing a one-shot query generated based on the multi-turn dialog in FIG. 2B, in accordance with various implementations of the present disclosure. As shown in FIG. 2A, a multi-turn dialog 201 can be pre-processed, e.g., using the pre-processing engine 1039, to generate a pre-processed multi-turn dialog 203. Based on processing the pre-processed multi-turn dialog 203, e.g., using a generative model 193, one or more one-shot queries candidates 207 (may shortly be referred to as “one or more one-shot queries”) can be generated. For example, in some implementations, a one-shot query generation request 204 can be generated, e.g., using a prompt generation engine 1031b, based on the pre-processed multi-turn dialog 203. The one shot query generation request 204 can be processed as input, by the LLM engine 1031b using the generative model 193, to generate a model output 205 indicating one or more one-shot queries 207 and/or one or more confidence scores 206 that are respectively associated with the one or more one-shot queries 207. Optionally, the one or more one-shot queries 207 can be ranked, based on the one or more confidence scores 206 each being a quality score estimated for a corresponding one-shot query from the one or more one-shot queries 207.

Optionally, the one-shot query generation request 204 can include, in addition to the pre-processed multi-turn dialog 203, an instruction 202 to generate a one-shot query based on the content of the pre-processed multi-turn dialog 203. In some implementations, the instruction 202 to generate the one-shot query can be, for instance, an instruction to generate a summary that summarizes user intent(s) from the pre-processed multi-turn dialog. The instruction 202 to generate the one-shot query can, optionally, request the summary that summarizes user intent(s) from the pre-processed multi-turn dialog (i.e., the one-shot query) to be one-paragraph long.

In various implementations, the multi-turn dialog 201 can include: multiple dialog turns that correspond to user input(s) (also referred to as “multiple user turns”) providing user intent(s) and associated parameter(s); and multiple dialog turns that correspond to input(s) from a virtual assistant (or a human agent/responder) that respond to the user input(s), e.g., that provides a prompt to seek values for one or more of the parameters associated with the user intent(s). The multiple dialog turns that correspond to input(s) from a virtual assistant (or a human agent/responder) may be referred to as “multiple assistant turns”.

As a working example, the multi-turn dialog 201 can be as follows:
“User_1: Hi, could you help me find a taxi out of Cocum?
Chatbot: Could you tell me when you would like to leave by and when you would like to arrive?
User_1: I need to be picked up by 15:00. Could you provide me the car type, please?
Chatbot: What is your final destination?
User_1: Oh, I'm sorry. I would like to travel to Gallery at Twelve High Street. I actually need to be there by 15:00.
Chatbot: OK, I can make that change.
User_1: When will the car arrive?
Chatbot: Unfortunately, it does not give me a specific arrival time. But if you like, you can call them to get that information. Their phone number is 07916703661
User_1: Thanks. I will call them. Can you tell me what type of car I will have?
Chatbot: Your car type is a white sedan.”

In the working example above, the multi-turn dialog 201 can include multiple user turns such as “Hi, could you help me find a taxi out of Cocum?”, “I need to be picked up by 15:00. Could you provide me the car type, please?”, “Oh, I'm sorry. I would like to travel to Gallery at Twelve High Street. I actually need to be there by 15:00.”, “When will the car arrive?”, and “Thanks. I will call them. Can you tell me what type of car I will have?”. In this working example, the multiple assistant turns include, for instance, “Could you tell me when you would like to leave by and when you would like to arrive?”, “What is your final destination?”, “OK, I can make that change.”, “Unfortunately, it does not give me a specific arrival time. But if you like, you can call them to get that information. Their phone number is 07916703661”, and “Your car type is a white sedan.”

In various implementations, the pre-processed multi-turn dialog 203 can include the multiple user turns, with a predefined user label (e.g., “USER”) assigned to each of the multiple user turns. In some implementations, the pre-processed multi-turn dialog 203 can further include the multiple assistant turns, with a predefined assistant label (e.g., “SYSTEM”, “Assistant”, etc.) assigned to each of the multiple assistant turns. In various implementations, the pre-processed multi-turn dialog 203 can include (and sometimes only include) the multiple user turns, without any user label (e.g., “USER”) assigned to any of the multiple user turns. In other words, in some implementations, optionally, if the multi-turn dialog includes user label(s), the pre-processing engine 1039 can pre-processes the multi-turn dialog by removing the user label(s) from the multi-turn dialog, or changing the user label(s) into a predefined user label. In some implementations, optionally, if the multi-turn dialog includes no user label and no system label, the pre-processing engine 1039 can pre-processes the multi-turn dialog to add the predefined user label and/or the predefined assistant label. The present disclosure, however, is not limited herein.

Continuing with the working example above and with reference to a one-shot query generation request 201A illustrated in FIG. 2B, the pre-processed multi-turn dialog 203 can include both multiple user turns (labeled with the predefined user label of “USER”) and multiple assistant turns (labeled with the predefined assistant label of “SYSTEM”), shown as follows:
“USER: Hi, could you help me find a taxi out of Cocum?
SYSTEM: Could you tell me when you would like to leave by and when you would like to arrive?
USER: I need to be picked up by 15:00. Could you provide me the car type, please?
SYSTEM: What is your final destination?
USER: Oh, I'm sorry. I would like to travel to Gallery at Twelve High Street. I actually need to be there by 15:00.
SYSTEM: OK, I can make that change.
USER: When will the car arrive?
SYSTEM: Unfortunately, it does not give me a specific arrival time. But if you like, you can call them to get that information. Their phone number is 07916703661
USER: Thanks. I will call them. Can you tell me what type of car I will have?
SYSTEM: Your car type is a white sedan.”

Correspondingly, the aforementioned instruction 202 (as shown in the one-shot query generation request 201B of FIG. 2C) to generate a one-shot query can be, for instance, “In the following [DIALOGUE], Pretend you're the USER. Summarize and say the request of the USER in one paragraph”.

Alternatively, continuing with the working example above and with reference to 201B of FIG. 2C, the pre-processed multi-turn dialog 203 can include (and only include) the multiple user turns, where each of the multiple user turns can be labeled with the predefined user label of “USER”), shown as follows:
“USER: Hi, could you help me find a taxi out of Cocum?
USER: I need to be picked up by 15:00. Could you provide me the car type, please?
USER: Oh, I'm sorry. I would like to travel to Gallery at Twelve High Street. I actually need to be there by 15:00.
USER: When will the car arrive?
USER: Thanks. I will call them. Can you tell me what type of car I will have?”

Correspondingly, the aforementioned instruction 202 (as shown in 201A of FIG. 2B) to generate a one-shot query can be, for instance, “In the following [DIALOGUE], the USER has a conversation with SYSTEM. Pretend you're the USER. Summarize and say the request of the USER in one paragraph”.

Alternatively, continuing with the working example above and with reference to 201C of FIG. 2D, the pre-processed multi-turn dialog 203 can include (and only include) the multiple user turns, where none of the multiple user turns is labeled with any user label, shown as follows:
“Hi, could you help me find a taxi out of Cocum?
I need to be picked up by 15:00. Could you provide me the car type, please?
Oh, I'm sorry. I would like to travel to Gallery at Twelve High Street. I actually need to be there by 15:00.
When will the car arrive?
Thanks. I will call them. Can you tell me what type of car I will have?”

Correspondingly, the aforementioned instruction 202 (as shown in 201C of FIG. 2C) to generate a one-shot query can be, for instance, “In the following [DIALOGUE], summarize and say the request in one paragraph”.

In some implementations, whether the one or more one-shot queries 207 (or a subset thereof, such as one or more top ranked one-shot queries from the one or more one-shot queries 207) accurately reflect user intent(s) and associated parameters can be verified, e.g., using the one-shot query verification engine 1033. In some implementations, the one-shot query verification engine 1033 can verify each of the one or more one-shot queries 207 (or a subset thereof) based on comparing a respective one-shot query with annotated actions (and/or annotated parameters) that are annotated from the multiple user turns in the multi-turn dialog 201, e.g., to determine whether actions (and/or associated parameters) from the respective one-shot query match the annotated actions (and/or annotated parameters, see 206A in FIG. 2F as a non-limiting example) from the multiple user turns of the multi-turn dialog 201. In some implementations, the one-shot query verification engine 1033 can communicate with the annotation engine 1037 that generates annotated data 206 (e.g., including the annotated actions and/or annotated parameters) from the multiple user turns of the multi-turn dialog 201, to retrieve the annotated actions (and/or annotated parameters) from the multiple user turns of the multi-turn dialog 20, for comparison.

In some implementations, a top ranked shot-shot query verified as accurately reflecting user intent(s) and associated parameters (which may be referred to as a verified one-shot query 209) can be selected, e.g., by the one-shot query selection engine 1035, and be included in a one-shot query dataset to be stored in the one-shot query database 130. Referring to FIG. 2E, the top ranked shot-shot query 209 can be, for instance, “Hi, I am looking for a taxi to get me from Cocum to Gallery at Twelve High Street by 15:00. I want to know the estimated arrival time, but if unavailable, I will call if a contact phone number can be provided. I also want to know the car type.”

In some implementations, the training instance generation engine 123 can generate a training instance T1 based on the verified one-shot query 209, to train or fine-tune a machine learning model (e.g., the aforementioned NLU machine learning model) in handling a complex use query that defines a user intent and parameters associated with the user intent, e.g., in a single utterance. For instance, the training instance T1 can include the verified one-shot query 209 (e.g., “Hi, I am looking for a taxi to get me from Cocum to Gallery at Twelve High Street by 15:00. I want to know the estimated arrival time, but if unavailable, I will call if a contact phone number can be provided. I also want to know the car type.”) as a training instance input. The training instance T1 can further include a ground truth output generated based at least on the multi-turn dialog 201 (or the pre-processed multi-turn dialog 203). For instance, the training instance generation engine 123 can generate the ground truth output based on the multi-turn dialog 201 and metadata associated with external tools or other services (e.g., APIs) for performing a task that fulfills user intent(s) in the verified one-shot query 209.

In some implementations, the training instance input can be processed, using a NLU machine learning model, to generate a training instance output. The training instance output can be compared with the ground truth output to determine a difference, and one or more parameters of the NLU machine learning model can be changed (e.g., fine-tuned) based on the difference.

FIG. 2G illustrates a user interface showing an additional example of a one-shot query generation request including a multi-turn dialog (e.g., pre-processed) and/or an instruction to generate a one-shot query based on the multi-turn dialog, in accordance with various implementations of the present disclosure. FIG. 2H illustrates a user interface showing an even further example of a one-shot query generation request including a multi-turn dialog (e.g., pre-processed) and/or an instruction to generate a one-shot query based on the multi-turn dialog, in accordance with various implementations of the present disclosure.

As shown in FIG. 2G and with reference to 201D of FIG. 2G, the pre-processed multi-turn dialog 203 can include both multiple user turns (labeled with the predefined user label of “USER”) and multiple assistant turns (labeled with the predefined assistant label of “SYSTEM”) shown as follows:
“USER: Hi, could you help me find a taxi out of Cocum?
SYSTEM: Could you tell me when you would like to leave by and when you would like to arrive?
USER: I need to be picked up by 15:00. Could you provide me the car type, please?
SYSTEM: What is your final destination?
USER: Oh, I'm sorry. I would like to travel to Gallery at Twelve High Street. I actually need to be there by 15:00.
SYSTEM: OK, I can make that change.
USER: When will the car arrive?
SYSTEM: Unfortunately, it does not give me a specific arrival time. But if you like, you can call them to get that information. Their phone number is 07916703661
USER: Thanks. I will call them. Can you tell me what type of car I will have?
SYSTEM: Your car type is a white sedan.”

Further referring to FIG. 2G, the aforementioned instruction 202 (as shown in FIG. 2A) to generate a one-shot query can be, for instance, “In the following [DIALOGUE], the USER has a conversation with SYSTEM. Pretend you are the USER. Remove all inputs from the SYSTEM, and remove all labels for the SYSTEM. Summarize and say the request in inputs from the USER, in one paragraph”.

Alternatively, continuing with the working example above and with reference to 201E of FIG. 2H, the pre-processed multi-turn dialog 203 can include both multiple user turns (labeled with the predefined user label of “USER”) and multiple assistant turns (labeled with the predefined assistant label of “SYSTEM”), shown as follows:
“USER: Hi, could you help me find a taxi out of Cocum?
SYSTEM: Could you tell me when you would like to leave by and when you would like to arrive?
USER: I need to be picked up by 15:00. Could you provide me the car type, please?
SYSTEM: What is your final destination?
USER: Oh, I'm sorry. I would like to travel to Gallery at Twelve High Street. I actually need to be there by 15:00.
SYSTEM: OK, I can make that change.
USER: When will the car arrive?
SYSTEM: Unfortunately, it does not give me a specific arrival time. But if you like, you can call them to get that information. Their phone number is 07916703661
USER: Thanks. I will call them. Can you tell me what type of car I will have?
SYSTEM: Your car type is a white sedan.”

Further referring to FIG. 2H, aforementioned instruction 202 (in FIG. 2A) to generate a one-shot query can be, for instance, “In the following [DIALOGUE], the USER has a conversation with SYSTEM. Remove all inputs from the SYSTEM and from the USER, and remove all labels for the SYSTEM and for the USER. Summarize and say user request in remaining content, in one paragraph”. It is noted that, the instructions (or the one-shot query generation request, e.g., 201A˜201E) illustrated in FIGS. 2B, 2C, 2D, 2G, and 2H, however, are not intended to be limiting.

FIG. 2F illustrates an example of metadata associated with an annotated multi-turn dialog determined from a multi-turn dialog in FIG. 2A, in accordance with various implementations of the present disclosure. In some implementations, the metadata associated with an annotated multi-turn dialog can be determined based on annotating a given multi-turn dialog (e.g., annotating user inputs from the given multi-turn dialog). As shown in FIG. 2F, the metadata 206A (e.g., “annotation metadata”) associated with the multi-turn dialog in FIG. 2A can include an annotated multi-turn dialog as follows:
“USER: Hi, could you help me find a taxi out of Cocum?
SYSTEM: Could you tell me when you would like to leave by and when you would like to arrive?
USER: I need to be picked up by 15:00. Could you provide me the car type, please?
SYSTEM: What is your final destination?
USER: Oh, I'm sorry. I would like to travel to Gallery at Twelve High Street. I actually need to be there by 15:00.
SYSTEM: OK, I can make that change.
USER: When will the car arrive?
SYSTEM: Unfortunately, it does not give me a specific arrival time. But if you like, you can call them to get that information. Their phone number is 07916703661
USER: Thanks. I will call them. Can you tell me what type of car I will have?
SYSTEM: Your car type is a white sedan.”

In some implementations, the metadata 206A associated with the annotated multi-turn dialog can, additionally, or alternatively, include one or more actions (e.g., “find a taxi”) and a plurality of parameters associated with the action(s). As a non-limiting example, as shown in FIG. 2F, the plurality of parameters associated the action (e.g., “find a taxi”) can include: a pickup location (e.g., “Cocum”), a drop off location (e.g., “Gallery at Twelve High Street”), a drop off time (e.g., “by 15:00”). The plurality of parameters can further include, e.g., a user preference for getting information about a “car type”. Such annotation metadata 206A or a portion thereof (e.g., the action of “find a taxi”, and the plurality of parameters associated with the action, such as “Cocum”) can be compared with one or more one-shot queries automatically generated from the multi-turn dialog in FIG. 2A, to determine whether any of the one or more one-shot queries is verified. For instance, the one-shot query 209 of “Hi, I am looking for a taxi to get me from Cocum to Gallery at Twelve High Street by 15:00. I want to know the estimated arrival time, but if unavailable, I will call if a contact phone number can be provided. I also want to know the car type.” can be determined as a verified query based on content (e.g., keywords) of the one-shot query 209 matches the action of “find a taxi” and the plurality of parameters in the annotation metadata 206A.

The aforementioned one-shot query such as “Hi, I am looking for a taxi to get me from Cocum to Gallery at Twelve High Street by 15:00. I need to know the car type and the phone number, as well as the estimated time of arrival” can be determined as not being a verified query (so that needs to be discarded and not saved in the one-shot query database 130). This is, for instance, based on such one-shot query including hallucination(s) such as “I need to know . . . phone number” which does not actually reflect a use intent since the user didn't initiate a query seeking phone number, but the system suggests the user to call the phone number. In other words, the one-shot query such as “Hi, I am looking for a taxi to get me from Cocum to Gallery at Twelve High Street by 15:00. I need to know the car type, as well as the estimated time of arrival” can be filtered out and not included in the one-shot query dataset based on content of such one-shot query including additional information (e.g., keyword indicating an entity) that is not included in the actions and parameters associated with the actions) in the metadata 206A.

Optionally, the metadata 206A associated with the multi-turn dialog can be generated, e.g., based on processing the multi-turn dialog and using a generative model. For instance, a request to annotate the multi-turn dialog (e.g., in natural language) can be generated, to include the multi-turn dialog and an instruction to extract keywords reflecting user intent and associated parameters from user inputs of the multi-turn dialog. The request to annotate the multi-turn dialog (e.g., in natural language) can be processed as input, using the generative model 193 or other generative model, to generate a model output reflecting one or more actions (e.g., “find a taxi”) and parameters (e.g., “Cocum”, “Gallery at Twelve High Street”, “by 15:00”, “car type”) associated with the one or more actions.

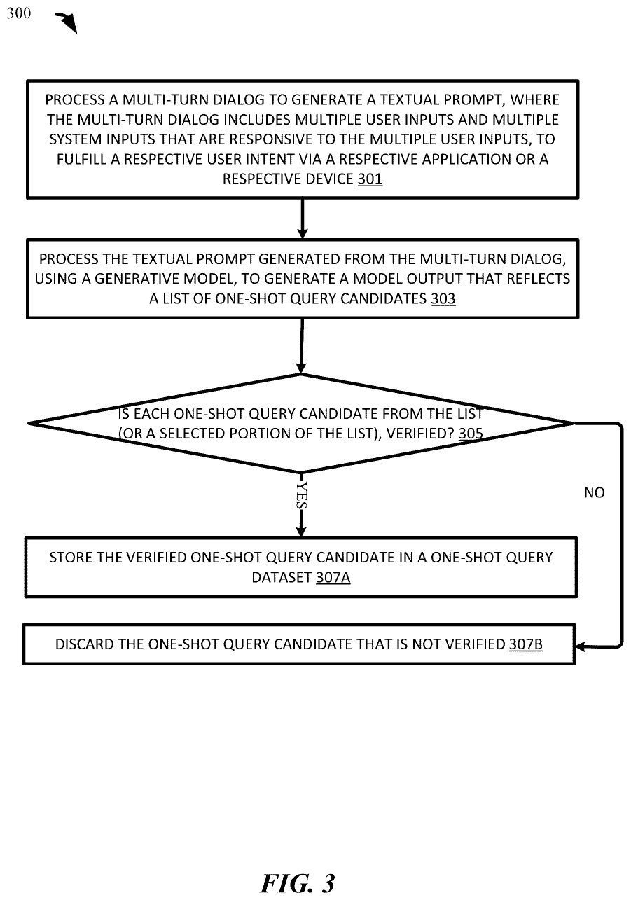

FIG. 3 illustrates an example of a method for generating one or more one-shot queries, in accordance with various implementations of the present disclosure. A system for performing the method 300 includes one or more processors, memory, and/or other component(s) of computing device(s) (e.g., client computing device 10 of FIG. 1, one or more servers, and/or other computing devices). Moreover, while operations of the method 300 are shown in a particular order, this is not meant to be limiting. One or more operations may be reordered, omitted, and/or added.

In various implementations, at block 301, the system processes a multi-turn dialog to generate a textual prompt (e.g., the aforementioned one-shot query generation request 204 in FIG. 2A), where the multi-turn dialog includes multiple user inputs and multiple system inputs that are responsive to the multiple user inputs, to fulfill a respective user intent via a respective application or a respective device.

In some of the various implementations, the system processes the multi-turn dialog to generate the textual prompt by at least pre-processing the multi-turn dialog to remove the multiple system inputs from the multi-turn dialog. In this case, the text prompt can at least include the pre-processed multi-turn dialog that excludes the multiple system inputs.

Additionally, or alternatively, in some of the various implementations, the system optionally determines whether the multi-turn dialog includes one or more user labels associated with the multiple user inputs. In response to determining that the respective multi-turn dialog includes the one or more user labels associated with the multiple user inputs, the system can pre-process the multi-turn dialog to remove the one or more user labels from the multi-turn dialog. In response to determining that the respective multi-turn dialog does not include any user label, the system can pre-process the respective multi-turn dialog to add one or more user labels for the multiple user inputs.

In some of the various implementations, the textual prompt includes an instruction that instructs to summarize the multiple user inputs given the multi-turn dialog.

In various implementations, at block 303, the system processes the textual prompt generated from the multi-turn dialog, using a generative model, to generate a model output that reflects a list of one-shot query candidates, where each one-shot query candidate from the list summarizes the multiple user inputs.

In various implementations, at block 305, the system determines whether the list of one-shot query candidates or a portion of the list is verified.

In some of the various implementations, the model output further reflects a respective confidence score for each one-shot query candidate in the list of one-shot query candidates. In this case, the system can verify the respective list of one-shot query candidates or the portion of the respective list by: selecting, based on the respective confidence scores, a top ranked one-shot query candidate having a highest confidence score from the respective list, and verifying the top ranked one-shot query candidate.

In some of the various implementations, the system further processes the multi-turn dialog to annotate one or more actions associated with the user intent, and/or one or more parameters associated with the user intent. In this case, the system can verify the list of one-shot query candidates (or the portion thereof) using the one or more annotated actions, and/or the one or more annotated values, that are associated with the user intent.

In some implementations, the system processes the multi-turn dialog to annotate the one or more actions and/or the one or more values by: generating an additional textual prompt based on the respective multi-turn dialog; and processing the additional textual prompt, using the generative model or an additional generative model, to generate a model output from which annotated content (e.g., annotated data 206 in FIG. 2A) that annotates the one or more actions and/or the one or more values is derived.

In various implementations, at block 307A, in response to a one-shot query candidate (e.g., a first one-shot query candidate) from the respective list being verified, the system stores the one-shot query candidate in a one-shot query dataset.

In various implementations, at block 307B, in response to the one-shot query candidate (e.g., at block 307A, or another one-shot query candidate from the list or a portion thereof) from the respective list not being verified, the system discards the one-shot query candidate, without storing the one-shot query candidate in the one-shot query dataset.

In various implementations, optionally, at block 309, the system generates a first training instance based at least on the first one-shot query candidate to train one or more machine learning models. The first training instance can be applied to train (or fine-tune) the one or more machine learning models via supervised learning (as described previously), or can be an instance to train (or fine-tune) the one or more machine learning models via RLHF.

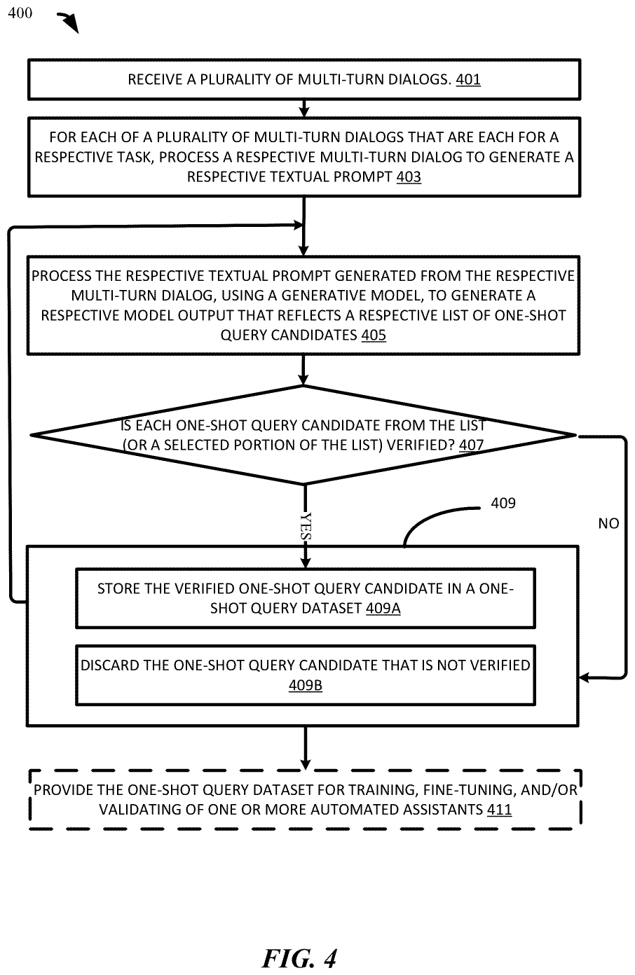

FIG. 4 depicts an example of a method for generating a one-shot query database, in accordance with various aspects of the present disclosure. A system for performing the method 400 includes one or more processors, memory, and/or other component(s) of computing device(s) (e.g., client computing device 10 of FIG. 1, one or more servers, and/or other computing devices). Moreover, while operations of the method 400 are shown in a particular order, this is not meant to be limiting. One or more operations may be reordered, omitted, and/or added.

In various implementations, at block 401, the system receives a plurality of multi-turn dialogs. In some implementations, optionally, the plurality of multi-turn dialogs can be retrieved, for instance, from one or more multi-turn dialog databases. In some implementations, optionally, the plurality of multi-turn dialogs can be acquired based on pre-processing multi-turn dialogs retrieved from the one or more multi-turn dialog databases.

In various implementations, at block 403, the system, for each of a plurality of multi-turn dialogs that are each for a respective task, processes a respective multi-turn dialog to generate a respective textual prompt. The respective multi-turn dialog can include, for instance, multiple user inputs and multiple system inputs that are responsive to the multiple user inputs, to fulfill a respective user intent via a respective application or a respective device;

In various implementations, at block 405, the system processes the respective textual prompt generated from the respective multi-turn dialog, using a generative model, to generate a respective model output that reflects a respective list of one-shot query candidates. Each one-shot query candidate from the respective list, for instance, summarizes the multiple user inputs.

In various implementations, at block 407, the system determines whether each one-shot query candidate from the respective list of one-shot query candidates (or a portion of the respective list) is verified. For instance, the system can determine whether each one-shot query candidate from the respective list of one-shot query candidates (or a portion of the respective list) is verified by determining whether each one-shot query candidate accurately summarizes multiple user inputs from the multi-turn dialog. In this case, the system can determine that a one-shot query candidate is verified based on determining that the one-shot query candidate accurately summarizes the multiple user inputs from the multi-turn dialog.

The system can determine that a one-shot query candidate is not verified based on determining that the one-shot query candidate does not accurately summarize the multiple user inputs from the multi-turn dialog. For example, the system can determine that a one-shot query candidate is not verified based on determining that the one-shot query candidate includes one or more hallucinations not matching aforementioned annotation metadata.

In various implementations, at block 409, the system generates a one-shot query dataset. For instance, at block 409A, the system, in response to a one-shot query candidate from the respective list being verified, stores the one-shot query candidate in a one-shot query dataset. Additionally, or alternatively, at block 409B, the system, in response to the one-shot query candidate from the respective list not being verified, discards the one-shot query candidate, without storing the one-shot query candidate in the one-shot query dataset.

In various implementations, at block 4011, the system provides the one-shot query dataset for training, fine-tuning, and/or validating of one or more automated assistants.

In some implementations, the one-shot query dataset can include verified one-shot queries associated with different user intents (e.g., food-ordering, calling a taxi, a combination thereof, etc.). As a non-limiting example, the one-shot query dataset can include a verified one-shot query (e.g., with a user intent of “booking a taxi”) such as, “I am requesting a taxi from FF Bed and Breakfast to DD Pizzeria. I would like to arrive at 1 μm to meet my friend for lunch. I would like the contact information for the driver so that I can reach them if necessary.” As another example, the one-shot query dataset can include a verified one-shot query (e.g., with a user intent of “ordering food”), such as, “I would like to place an order for Indian food for three people. I would like to order beef shish kebabs for one person, chicken tandoori for one person, and green curry with chicken for the third person. I would also like to add garlic to all of the dishes.”

As a further example, the one-shot query dataset can include a verified one-shot query (e.g., with user intents of “ordering food”, “search attraction” and “booking taxi service”), such as, “I am planning a trip to Cambridge and I need your help with booking a restaurant and a taxi. I am looking for an expensive restaurant serving British food in the west area of Cambridge. I would like to book a table for one on Tuesday at 7:30 PM. I am also looking for an attraction in the same area. Can you recommend one and provide me with their phone number? I would like to take a taxi between the restaurant and the attraction. I would like to leave the attraction by 7:15 PM.”

It is noted that, training, fine-tuning, or validating one or more machine learning (ML) models using the examples of verified one-shot queries as shown above enhances capabilities of virtual assistant, chatbot, or other interactive services or applications that include (or access) one or more of the ML models in handling complex user input (e.g., a single typed or spoken user input as complex as the examples given above) by having an accurate understanding of user intent(s) in the complex user input.

In some implementations, the method 400 further includes: determining a type (or category) of a user intent for each multi-turn dialog from the plurality of multi-turn dialogs. In some implementations, different multi-turn dialogs corresponding to different types/categories of user intents can be pre-processed in a different manner. For instance, for a multi-turn dialog corresponding to a user intent of “ordering food”, the multi-turn dialog can be pre-processed to remove any user labels. For instance, for a multi-turn dialog corresponding to a user intent of “ordering food and reserving a taxi”, the multi-turn dialog can be pre-processed to add user labels (or reserve existing user labels). The present disclosure, however, is not limited to descriptions herein.

As another example, the text prompt can be configured in a different manner (as described previously) for multi-turn dialogs corresponding to different user intents.

In some of the various implementations above, the model output further reflects a respective confidence score for each one-shot query candidate in the respective list of one-shot query candidates. In this case, verifying the respective list of one-shot query candidates or the portion of the respective list includes: selecting, based on the respective confidence scores, a top ranked one-shot query candidate having a highest confidence score from the respective list, and verifying the top ranked one-shot query candidate (e.g., by determining whether the top ranked one-shot query candidate accurately reflects a corresponding user intent).

In some of the various implementations, the method 400 further includes: processing the respective multi-turn dialog to annotate one or more actions associated with the respective user intent, and/or one or more values associated with the respective user intent. In this case, verifying the respective list of one-shot query candidates or the portion of the respective list is performed using the one or more annotated actions, and/or the one or more annotated values, that are associated with the respective user intent.

In some of the various implementations, processing the respective multi-turn dialog to annotate the one or more actions and/or the one or more values includes: generating an additional textual prompt based on the respective multi-turn dialog; and processing the additional textual prompt, using the generative model or an additional generative model, to generate a model output from which annotated content that annotates the one or more actions and/or the one or more values is derived.

In some of the various implementations, processing the respective multi-turn dialog to generate the respective textual prompt can include: pre-processing the respective multi-turn dialog to remove the multiple system inputs from the respective multi-turn dialog.

In some of the various implementations, processing the respective multi-turn dialog to generate the respective textual prompt can include: determining whether the respective multi-turn dialog includes one or more user labels associated with the multiple user inputs; and in response to determining that the respective multi-turn dialog includes the one or more user labels associated with the multiple user inputs, pre-processing the respective multi-turn dialog to remove the one or more user labels from the respective multi-turn dialog.

In some of the various implementations, processing the respective multi-turn dialog to generate the respective textual prompt can include: determining whether the respective multi-turn dialog includes any user label; and in response to determining that the respective multi-turn dialog does not include any user label, pre-processing the respective multi-turn dialog to add one or more user labels for the multiple user inputs.

In some of the various implementations, the respective textual prompt includes an instruction that instructs to summarize the multiple user inputs given the respective multi-turn dialog.

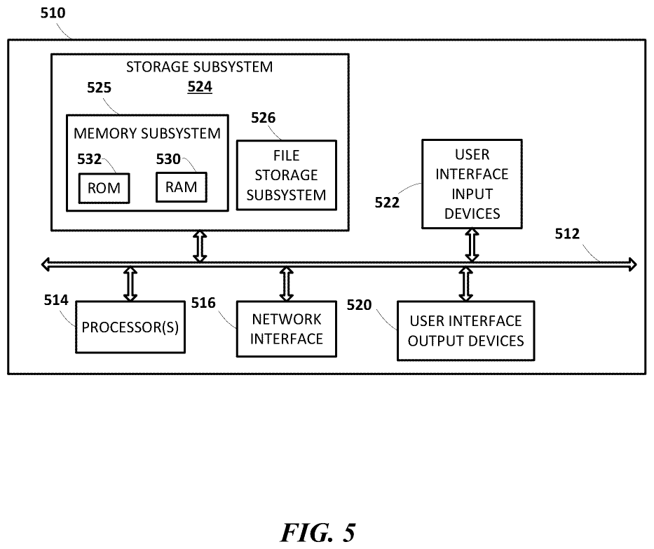

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A computer-implemented method comprising:
for each of a plurality of multi-turn dialogs that are each for a respective task:
processing a respective multi-turn dialog to generate a respective textual prompt, wherein the respective multi-turn dialog includes multiple user inputs and multiple system inputs, that are responsive to the multiple user inputs, to fulfill a respective user intent via a respective application or a respective device;
processing the respective textual prompt generated from the respective multi-turn dialog, using a generative model, to generate a respective model output that reflects a respective list of one-shot query candidates;
determining whether the respective list of one-shot query candidates or a portion of the respective list is verified;
generating a one-shot query dataset, comprising:
in response to a first one-shot query candidate from the respective list being verified, storing the first one-shot query candidate in the one-shot query dataset, and
in response to the first one-shot query candidate from the respective list not being verified, discarding the first one-shot query candidate, without storing the first one-shot query candidate in the one-shot query dataset; and
providing the one-shot query dataset for training, fine-tuning, and/or validating of one or more automated assistants.

2. The computer-implemented method of claim 1, wherein:
the model output further reflects a respective confidence score for each one-shot query candidate in the respective list of one-shot query candidates, and
verifying the respective list of one-shot query candidates or the portion of the respective list comprises:
selecting, based on the respective confidence scores, a top ranked one-shot query candidate having a highest confidence score from the respective list, and
verifying the top ranked one-shot query candidate.

3. The computer-implemented method of claim 1, further comprising:
processing the respective multi-turn dialog to annotate one or more actions associated with the respective user intent, and/or one or more values associated with the respective user intent,
wherein verifying the respective list of one-shot query candidates or the portion of respective is performed using the one or more annotated actions, and/or the one or more annotated values, that are associated with the respective user intent.

4. The computer-implemented method of claim 3, wherein processing the respective multi-turn dialog to annotate the one or more actions and/or the one or more values comprises:
generating an additional textual prompt based on the respective multi-turn dialog, and
processing the additional textual prompt, using the generative model or an additional generative model, to generate a model output from which annotated content that annotates the one or more actions and/or the one or more values is derived.

5. The computer-implemented method of claim 1, wherein processing the respective multi-turn dialog to generate the respective textual prompt comprises:
pre-processing the respective multi-turn dialog to remove the multiple system inputs from the respective multi-turn dialog.

6. The computer-implemented method of claim 1, wherein processing the respective multi-turn dialog to generate the respective textual prompt comprises:
determining whether the respective multi-turn dialog includes one or more user labels associated with the multiple user inputs, and
in response to determining that the respective multi-turn dialog includes the one or more user labels associated with the multiple user inputs, pre-processing the respective multi-turn dialog to remove the one or more user labels from the respective multi-turn dialog.

7. The computer-implemented method of claim 1, wherein processing the respective multi-turn dialog to generate the respective textual prompt comprises:
determining whether the respective multi-turn dialog includes any user label, and
in response to determining that the respective multi-turn dialog does not include any user label, pre-processing the respective multi-turn dialog to add one or more user labels for the multiple user inputs.

8. The computer-implemented method of claim 1, wherein the respective textual prompt includes an instruction that instructs to summarize the multiple user inputs given the respective multi-turn dialog.

9. A computing system, comprising one or more processor devices and one or more tangible, non-transitory computer readable media storing computer-readable instructions that when executed by the one or more processor devices cause the one or more processor devices to perform operations, the operations comprising:
for each of a plurality of multi-turn dialogs that are each for a respective task:
processing a respective multi-turn dialog to generate a respective textual prompt, wherein the respective multi-turn dialog includes multiple user inputs and multiple system inputs, that are responsive to the multiple user inputs, to fulfill a respective user intent via a respective application or a respective device;
processing the respective textual prompt generated from the respective multi-turn dialog, using a generative model, to generate a respective model output that reflects a respective list of one-shot query candidates;
determining whether the respective list of one-shot query candidates or a portion of the respective list is verified;
generating a one-shot query dataset, comprising:
in response to a first one-shot query candidate from the respective list being verified, storing the first one-shot query candidate in the one-shot query dataset, and
in response to a second one-shot query candidate from the respective list not being verified, discarding the second one-shot query candidate, without storing the second one-shot query candidate in the one-shot query dataset; and
providing the one-shot query dataset for training, fine-tuning, and/or validating of one or more automated assistants.

10. The system of claim 9, wherein the model output further reflects a respective confidence score for each one-shot query candidate in the respective list of one-shot query candidates, and the computer-readable instructions, when executed by the one or more processor devices, cause the one or more processor devices to perform the operation of verifying the respective list of one-shot query candidates or the portion of the respective list by:
selecting, based on the respective confidence scores, a top ranked one-shot query candidate having a highest confidence score from the respective list, and
verifying the top ranked one-shot query candidate.

11. The system of claim 9, further comprising computer-readable instructions that, when executed by the one or more processor devices, cause the one or more processor devices to perform the operation of:
processing the respective multi-turn dialog to annotate one or more actions associated with the respective user intent, and/or one or more values associated with the respective user intent,
wherein verifying the respective list of one-shot query candidates or the portion of respective is performed using the one or more annotated actions, and/or the one or more annotated values, that are associated with the respective user intent.

12. The system of claim 11, wherein the computer-readable instructions, when executed by the one or more processor devices, cause the one or more processor devices to perform the operation of processing the respective multi-turn dialog to annotate the one or more actions and/or the one or more values by:
generating an additional textual prompt based on the respective multi-turn dialog, and
processing the additional textual prompt, using the generative model or an additional generative model, to generate a model output from which annotated content that annotates the one or more actions and/or the one or more values is derived.

13. The system of claim 9, wherein the computer-readable instructions that, when executed by the one or more processor devices, cause the one or more processor devices to perform the operation of processing the respective multi-turn dialog to generate the respective textual prompt by:
pre-processing the respective multi-turn dialog to remove the multiple system inputs from the respective multi-turn dialog.

14. The system of claim 9, wherein the computer-readable instructions that, when executed by the one or more processor devices, cause the one or more processor devices to perform the operation of processing the respective multi-turn dialog to generate the respective textual prompt by:
determining whether the respective multi-turn dialog includes one or more user labels associated with the multiple user inputs, and
in response to determining that the respective multi-turn dialog includes the one or more user labels associated with the multiple user inputs, pre-processing the respective multi-turn dialog to remove the one or more user labels from the respective multi-turn dialog.

15. The system of claim 9, wherein the computer-readable instructions that, when executed by the one or more processor devices, cause the one or more processor devices to perform the operation of processing the respective multi-turn dialog to generate the respective textual prompt by:
determining whether the respective multi-turn dialog includes any user label, and
in response to determining that the respective multi-turn dialog does not include any user label, pre-processing the respective multi-turn dialog to add one or more user labels for the multiple user inputs.

16. The system of claim 9, wherein the textual respective prompt includes an instruction that instructs to summarize the multiple user inputs given the respective multi-turn dialog.

17. One or more tangible, non-transitory computer readable media storing computer-readable instructions that when executed by one or more processor devices cause the one or more processor devices to perform operations, the operations comprising:
for each of a plurality of multi-turn dialogs that are each for a respective task:
processing a respective multi-turn dialog to generate a respective textual prompt, wherein the respective multi-turn dialog includes multiple user inputs and multiple system inputs, that are responsive to the multiple user inputs, to fulfill a respective user intent via a respective application or a respective device;
processing the respective textual prompt generated from the respective multi-turn dialog, using a generative model, to generate a respective model output that reflects a respective list of one-shot query candidates;
determining whether the respective list of one-shot query candidates or a portion of the respective list;
generating a one-shot query dataset, comprising:
in response to a first one-shot query candidate from the respective list being verified, storing the first one-shot query candidate in the one-shot query dataset, and
in response to a second one-shot query candidate from the respective list not being verified, discarding the second one-shot query candidate, without storing the second one-shot query candidate in the one-shot query dataset; and
providing the one-shot query dataset for training, fine-tuning, and/or validating of one or more automated assistants.

18. The computer readable media of claim 17, wherein the model output further reflects a respective confidence score for each one-shot query candidate in the respective list of one-shot query candidates, and the computer readable media further stores computer-readable instructions that, when executed by the one or more processor devices, cause the one or more processor devices to perform the operation of verifying the respective list of one-shot query candidates or the portion of the respective list by:
selecting, based on the respective confidence scores, a top ranked one-shot query candidate having a highest confidence score from the respective list, and
verifying the top ranked one-shot query candidate.

19. The computer readable media of claim 17, further storing computer-readable instructions that, when executed by the one or more processor devices, cause the one or more processor devices to perform the operation of:
processing the respective multi-turn dialog to annotate one or more actions associated with the respective user intent, and/or one or more values associated with the respective user intent,
wherein verifying the respective list of one-shot query candidates or the portion of respective is performed using the one or more annotated actions, and/or the one or more annotated values, that are associated with the respective user intent.

20. The computer readable media of claim 19, further storing computer-readable instructions that, when executed by the one or more processor devices, cause the one or more processor devices to perform the operation of processing the respective multi-turn dialog to annotate the one or more actions and/or the one or more values by:
generating an additional textual prompt based on the respective multi-turn dialog, and
processing the additional textual prompt, using the generative model or an additional generative model, to generate a model output from which annotated content that annotates the one or more actions and/or the one or more values is derived.
